(19) United States
(12) Patent Application Publication
(10) Pub. No.: US 2025/0051544 A1
(43) Pub. Date: Feb. 13, 2025

(54) RUBBER COMPOSITION

(71) Applicant: COMPAGNIE GENERALE DES ETABLISSEMENTS MICHELIN, Clermont-Ferrand (FR)

(72) Inventors: STEPHANIE LAUBE, Clermont-Ferrand (FR); SALVATORE PAGANO, Clermont-Ferrand (FR); ANGELIQUE PAWLAK, Clermont-Ferrand (FR)

(21) Appl. No.: 18/720,006

(22) PCT Filed: Dec. 13, 2022
(86) PCT No.: PCT/EP2022/085682

§ 371 Date: Jun. 14, 2024

(30) Foreign Application Priority Data
Dec. 16, 2021 (FR) FR2113626

(51) Int. Cl. C08K 5/13; C08K 3/04; C08K 5/107

(52) U.S. Cl. CPC C08K 5/13; C08K 3/04; C08K 5/107; C08K 2201/012

(57) ABSTRACT

A rubber composition is based on at least a diene elastomer, a reinforcing filler, a crosslinking system and a phenolic antioxidant of general formula (I), in which the R₁ radical represents an alkyl group comprising from 1 to 18 carbon atoms, an aryl group comprising from 6 to 10 carbon atoms or a hydrocarbon group of 2 to 12 carbon atoms comprising a heteroatom selected from O, N or S.

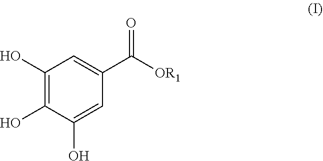

The field of the present invention is that of rubber compositions, the rubber compositions being particularly intended to be used in rubber articles, such as, for example, tyres.

Rubber articles are sensitive to oxidation, in particular during their ageing, and require systems for protection against this oxidation. To this end, a person skilled in the art has available a certain number of antioxidants which he commonly uses in rubber compositions.

Nevertheless, it is advantageous, in a general context where it is sought to be freed from the dependence of industry on petroleum-sourced or non-durable products, to look for antioxidants which may be of natural origin so as to limit compounds of fossil origin in rubber articles, and in particular in tyres.

Antioxidants of phenolic type, including hindered phenolic compounds, constitute a class of the most important antioxidants, widely used because of their antioxidant activities even with a low content.

Propyl gallate belongs to this class of antioxidants and as such has long been used as food additive to prevent oxidation of foods containing oils and fats.

Esters of gallic acid are also described in CN106032397A as being able to be used as stabilizers during the synthesis of functionalized diene elastomers, very particularly propyl gallate.

On continuing its research studies, the applicant company has discovered that the use of a gallic acid ester in a rubber composition comprising a diene elastomer, a reinforcing filler and a crosslinking system makes it possible to protect this composition against oxidation and thus to improve the properties of this composition after ageing.

Thus, a first subject matter of the invention is a rubber composition based on at least a diene elastomer, a reinforcing filler, a crosslinking system and a phenolic antioxidant of general formula (I) below, in which the R₁ radical represents an alkyl group comprising from 1 to 18 carbon atoms, or an aryl group comprising from 6 to 10 carbon atoms, or a hydrocarbon group of 2 to 12 carbon atoms comprising a heteroatom selected from O, N or S.

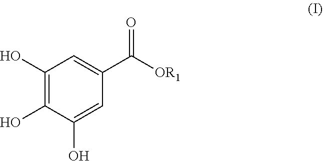

Another subject matter of the invention is a rubber article comprising a composition according to the invention. More particularly, another subject matter of the invention is a tyre comprising a composition according to the invention.

### I—DEFINITIONS

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state.

Within the meaning of the present invention, the expression “part by weight per hundred parts by weight of elastomer” (or phr) should be understood as meaning the part by weight per hundred parts by weight of elastomer.

In the present document, unless expressly indicated otherwise, all the percentages (%) indicated are percentages (%) by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b). In the present document, when an interval of values is denoted by the expression “from a to b”, the interval represented by the expression “between a and b” is also and preferentially denoted.

The compounds mentioned in the description can be of fossil origin or be biobased. In the latter case, they can, partially or completely, result from biomass or be obtained from renewable starting materials resulting from biomass. In the same way, the compounds mentioned can also originate from the recycling of pre-used materials, that is to say that they can, partially or completely, result from a recycling process, or else be obtained from starting materials themselves resulting from a recycling process. Polymers, plasticizers, fillers, and the like, are concerned in particular.

### II—DESCRIPTION OF THE INVENTION

### II-1 Elastomer Matrix

The term “diene elastomer” (or, without distinction, “rubber”), whether natural or synthetic, should be understood, in a known way” as meaning an elastomer consisting, at least partially (i.e. a homopolymer or a copolymer), of diene monomer units (monomers bearing two conjugated or non-conjugated carbon-carbon double bonds).

The term “diene elastomer capable of being used in the compositions in accordance with the invention” is understood in particular to mean:
(a)—any homopolymer of a conjugated or non-conjugated diene monomer having from 4 to 24 carbon atoms;
(b)—any copolymer of a conjugated or non-conjugated diene having from 4 to 24 carbon atoms and of at least one other monomer.

The term “copolymer of a conjugated or non-conjugated diene having from 4 to 24 carbon atoms and of at least one other monomer” should be understood as meaning a copolymer of a diene and of one or more other monomer(s). Mention may be made, as other monomer, of ethylene, an olefin and a conjugated or non-conjugated diene other than the first diene.

Suitable as conjugated dienes are conjugated dienes having from 4 to 24 carbon atoms, in particular 1,3-dienes having from 4 to 12 carbon atoms, such as in particular 1,3-butadiene and isoprene, or also a 1,3-diene of formula CH₂═CR—CH═CH₂, in which R represents a hydrocarbon chain having from 3 to 20 carbon atoms, such as, for example, a linear monoterpene (C₁₀H₁₆), such as myrcene, a linear sesquiterpene (C₁₅H₂₄), such as farnesene, and the like. Very particularly, suitable as conjugated dienes are 1,3-butadiene, isoprene, myrcene and farnesene.

Suitable as non-conjugated dienes are non-conjugated dienes having from 6 to 12 carbon atoms, such as 1,4-hexadiene, ethylidenenorbornene or dicyclopentadiene.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl) styrene.

Suitable as aliphatic α-monoolefins are in particular acyclic aliphatic α-monoolefins having from 3 to 18 carbon atoms.

More particularly, the diene elastomer is:
a′)—any homopolymer of a conjugated diene monomer, in particular any homopolymer obtained by polymerization of a conjugated diene monomer having from 4 to 12 carbon atoms;
(b′)—any copolymer obtained by copolymerization of one or more conjugated dienes with one another or with one or more vinylaromatic compounds having from 8 to 20 carbon atoms;
(c′)—any copolymer obtained by copolymerization of ethylene with one or more conjugated dienes.

Preferentially, the diene elastomer is selected from the group consisting of polybutadienes (BRs), natural rubber (NR), synthetic polyisoprenes (IRs), butadiene copolymers, isoprene copolymers and the mixtures of these elastomers. The butadiene copolymers are particularly selected from the group consisting of butadiene-styrene copolymers (SBRs), ethylene-butadiene copolymers (EBRs) and terpolymers of ethylene, of butadiene and of another conjugated diene monomer, in particular isoprene, myrcene or farnesene.

The diene elastomer can be modified, that is to say either coupled and/or star-branched, or functionalized, or coupled and/or star-branched and simultaneously functionalized. Thus, the diene elastomer can be coupled and/or star-branched, for example by means of a silicon or tin atom which connects the elastomer chains together.

The diene elastomer can be simultaneously or alternatively functionalized and comprise at least one functional group. The term “functional group” is understood to mean a group comprising at least one heteroatom selected from Si, N, S, O or P. Particularly suitable as functional groups are those comprising at least one function, such as: silanol, an alkoxysilane, a primary, secondary or tertiary amine which is cyclic or non-cyclic, a thiol or an epoxide.

The rubber composition of the invention can contain just one diene elastomer or a mixture of several diene elastomers.

### II-2 Specific Antioxidant

According to the invention, the rubber composition is based on at least one ester of gallic acid, which is a phenolic antioxidant of general formula (I) below,

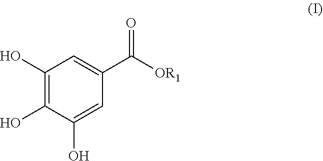

in which:
   the R₁ radical represents an alkyl group comprising from 1 to 18 carbon atoms, an aryl group comprising from 6 to 10 carbon atoms or a hydrocarbon group of 2 to 12 carbon atoms comprising a heteroatom selected from O, N or S.

The hydrocarbon group of 2 to 12 carbon atoms comprising a heteroatom selected from O, N or S is preferentially an alkylaryl group comprising from 7 to 20 carbon atoms. Preferentially, the R₁ radical represents a methyl, ethyl, propyl, isopropyl, butyl, isobutyl, sec-butyl, tert-butyl or isopentyl group. R₁ is very preferentially an ethyl group.

The esters of gallic acid of general formula (I) above exhibit the advantage of being able to be biobased since they are found in the natural state, for example in tea leaves, oak bark, tara fruit pods or pomegranate peel. Gallic acid can easily be isolated by extraction from hydrolysable tannin contained in certain plants. The esters of gallic acid can subsequently be obtained by simple chemical modifications within the reach of any chemist. Esters of gallic acid are also commercially available, sold, for example, by Sigma-Aldrich.

Preferably, for the requirements of the invention, the phenolic antioxidant of general formula (I) is present in the composition at a content within a range extending from 0.2 to 10 phr, preferably from 0.5 to 8 phr and more preferentially from 0.8 to 5 phr.

### II-3 Reinforcing Filler

Another essential feature of the rubber composition in accordance with the invention is that it comprises a reinforcing filler.

Use may be made of any type of “reinforcing” filler known for its abilities to reinforce a rubber composition which can be used in particular for the manufacture of tyres, for example an organic filler, such as carbon black, an inorganic filler, such as silica, or also a mixture of these two types of fillers.

Suitable as carbon blacks are all carbon blacks, in particular the blacks conventionally used in tyres or their treads. Mention will more particularly be made, among the latter, of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks). These carbon blacks can be used in the isolated state, as commercially available, or in any other form, for example as support for some of the rubber additives used. The carbon blacks might, for example, be already incorporated into the diene elastomer, in particular an isoprene elastomer, in the form of a masterbatch (see, for example, patent applications WO 97/36724-A2 and WO 99/16600-A1).

Mention may be made, as examples of organic fillers other than carbon blacks, of functionalized polyvinyl organic fillers, such as described in Applications WO2006/069792-A1, WO2006/069793-A1, WO2008/003434-A1 and WO2008/003435-A1.

“Reinforcing inorganic filler” should be understood here as meaning any inorganic or mineral filler, whatever its colour and its origin (natural or synthetic), also referred to as “white” filler, “clear” filler or even “non-black” filler, in contrast to carbon black, capable of reinforcing, by itself alone, without means other than an intermediate coupling agent, a rubber composition intended for the manufacture of tyres. In a known way, certain reinforcing inorganic fillers can be characterized in particular by the presence of hydroxyl (—OH) groups at their surface.

Suitable in particular as reinforcing inorganic fillers are mineral fillers of the siliceous type, preferentially silica (SiO₂), or of the aluminous type, in particular alumina (Al₂O₃). The silica used can be any reinforcing silica known to a person skilled in the art, in particular any precipitated or fumed silica exhibiting a BET specific surface and a CTAB specific surface both of less than 450 m²/g, preferably within a range extending from 30 to 400 m²/g, in particular from 60 to 300 m²/g.

Use may be made of any type of precipitated silica, in particular highly dispersible precipitated silicas (HDS, for “highly dispersible silicas”). These precipitated silicas, which are or are not highly dispersible, are well known to a person skilled in the art. Mention may be made, for example, of the silicas described in Applications WO 03/016215-A1 and WO 03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silicas, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

Mention may also be made, as other examples of inorganic fillers capable of being used in the rubber compositions of the invention, of mineral fillers of the aluminous type, in particular alumina (Al₂O₃), aluminium oxides, aluminium hydroxides or aluminosilicates, titanium oxides, silicon carbides or nitrides, all of the reinforcing type, such as described, for example, in Applications WO 99/28376-A2, WO 00/73372-A1, WO 02/053634-A1, WO2004/003067-A1, WO2004/056915-A2, U.S. Pat. No. 6,610,261-B1 and U.S. Pat. No. 6,747,087-B2.

Mention may in particular be made of the aluminas Baikalox A125 or CR125 (Baïkowski), APA-100RDX (Condéa), Aluminoxid C (Evonik) or AKP-G015 (Sumitomo Chemicals).

The physical state in which the reinforcing inorganic filler is provided is not important, whether it is in the form of a powder, of micropearls, of granules or else of beads or any other appropriate densified form. Of course, “reinforcing inorganic filler” is also understood also to mean mixtures of different reinforcing inorganic fillers, in particular of silicas as described above.

A person skilled in the art will understand that, as replacement for the reinforcing inorganic filler described above, use might be made of a reinforcing filler of another nature, provided that this reinforcing filler of another nature is covered with an inorganic layer, such as silica, or else comprises functional sites, in particular hydroxyl sites, at its surface which require the use of a coupling agent in order to establish the bond between this reinforcing filler and the diene elastomer. Mention may be made, by way of example, of carbon blacks partially or completely covered with silica, or of carbon blacks modified by silica, such as, without limitation, the fillers of Ecoblack® type of the CRX2000 series or of the CRX4000 series from Cabot Corporation.

Preferably for the invention, the reinforcing filler is selected from the group consisting of carbon blacks, silicas and their mixtures.

A person skilled in the art will know how to adjust the total content of reinforcing filler according to the use concerned, in particular for example according to the type of tyres concerned, for example a tyre for a motorcycle, for a passenger vehicle or for a utility vehicle, such as a van or heavy-duty vehicle. Preferably, this total content of reinforcing filler is within a range extending from 10 to 200 phr, more preferentially from 30 to 180 phr and more preferentially still from 40 to 160 phr, the optimum being, in a known way, different according to the specific applications targeted.

In the present disclosure, the BET specific surface is determined by gas adsorption using the Brunauer-Emmett-Teller method described in “The Journal of the American Chemical Society”, (Vol. 60, page 309, February 1938), and more specifically according to a method adapted from Standard NF ISO 5794-1, Appendix E, of June 2010 [multipoint (5 point) volumetric method-gas: nitrogen-degassing under vacuum: one hour at 160° C.—relative pressure p/p₀ range: 0.05 to 0.17].

For the inorganic fillers, such as silica, for example, the CTAB specific surface values were determined according to Standard NF ISO 5794-1, Appendix G, of June 2010. The process is based on the adsorption of CTAB (N-hexadecyl-N,N,N-trimethylammonium bromide) on the “outer” surface of the reinforcing filler.

In order to couple the reinforcing inorganic filler to the diene elastomer, use may be made, in a well-known way, of an at least bifunctional coupling agent (or bonding agent) intended to provide a satisfactory interaction, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound can comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of organosilane polysulfides (symmetrical or asymmetrical), such as bis(3-triethoxysilylpropyl) tetrasulfide, abbreviated to TESPT, sold under the name Si69 by Evonik, or bis(3-triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl) propyl) octanethioate, sold by Momentive under the name NXT Silane. More preferentially, the organosilane is an organosilane polysulfide.

Of course, use might also be made of mixtures of the coupling agents described above. The content of coupling agent in the composition of the invention is advantageously less than or equal to 30 phr, it being understood that it is generally desirable to use as little as possible thereof. Typically, the content of coupling agent represents from 0.5% to 15% by weight, with respect to the amount of reinforcing inorganic filler. Its content is preferentially within a range extending from 0.5 to 20 phr, more preferentially within a range extending from 1 to 15 phr. This content is easily adjusted by a person skilled in the art according to the content of reinforcing inorganic filler used in the composition of the invention.

### II-4 Crosslinking System

The crosslinking system can be any type of system known to a person skilled in the art in the field of tyre rubber compositions. It can in particular be based on sulfur and/or on peroxide and/or on bismaleimides.

Preferentially, the crosslinking system is based on sulfur; it is then called a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or equivalent compound, such as stearic acid salts, and salts of transition metals, guanidine derivatives (in particular diphenylguanidine), or also known vulcanization retarders.

The sulfur is used at a preferential content of between 0.2 phr and 10 phr. The primary vulcanization accelerator is used at a preferential content of between 0.5 and 10 phr, more preferentially of between 0.5 and 5 phr.

Use may be made, as accelerator, of any compound capable of acting as accelerator of the vulcanization of diene elastomers in the presence of sulfur, in particular accelerators of the thiazole type, and also their derivatives, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

### II-5 Possible Additives

The rubber compositions according to the invention can optionally also comprise all or part of the usual additives generally used in tyre elastomer compositions, such as, for example, pigments, protective agents, such as antiozone waxes, chemical antiozonants or antioxidants other than the phenolic antioxidant of general formula (I), anti-fatigue agents, promoters of adhesion to metal reinforcements, in particular based on cobalt salts (such as cobalt acetylacetonate, cobalt resinate, cobalt 2-ethylhexanoate or cobalt hydroxide), or also reinforcing resins (such as described, for example, in Application WO 02/10269).

### II-6 Preparation of the Rubber Compositions

The compositions in accordance with the invention can be manufactured in appropriate mixers, using two successive preparation phases well known to a person skilled in the art:
a first phase of thermomechanical working or kneading (“non-productive” phase), which can be carried out in a single or several thermomechanical stages during which all the necessary constituents, in particular the elastomer matrix, the reinforcing filler, the phenolic antioxidant of general formula (I) and the optional other various additives, with the exception of the crosslinking system, are introduced into an appropriate mixer, such as a standard internal mixer (for example of ‘Banbury’ type). The incorporation of the optional filler in the elastomer can be carried out in one or more goes by thermomechanically kneading. In the case where the filler is already incorporated, in all or in part, in the elastomer in the form of a masterbatch, as is described, for example, in Applications WO 97/36724 and WO 99/16600, it is the masterbatch which is directly kneaded and, if appropriate, the other elastomers or fillers present in the composition which are not in the masterbatch form, and also the phenolic antioxidant of formula (I) and the optional other various additives, with the exception of the crosslinking system, are incorporated. The non-productive phase can be carried out at high temperature, up to a maximum temperature of between 110° C. and 200° C., preferably between 130° C. and 185° C., for a period of time generally of between 2 and 10 minutes;
a second phase of mechanical working (“productive” phase), which is carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

Such phases have been described, for example, in Applications EP-A-0 501 227, EP-A-0 735 088, EP-A-0 810 258, WO 00/05300 or WO 00/05301.

The final composition thus obtained is subsequently calendered, for example in the form of a sheet or of a plaque, in particular for a laboratory characterization, or also extruded (or co-extruded with another rubber composition) in the form of a rubber semi-finished product (or profiled element) which can be used, for example, as a tyre sidewall. These products can subsequently be used in the manufacture of tyres, according to the techniques known to a person skilled in the art.

The composition can be either in the raw state (before crosslinking or vulcanization) or in the cured state (after crosslinking or vulcanization), can be a semi-finished product which can be used in a tyre.

The crosslinking (or curing), if appropriate the vulcanization, is carried out in a known way at a temperature generally of between 130° C. and 200° C., for a sufficient time which can vary, for example, between 5 and 90 min as a function in particular of the curing temperature, of the crosslinking system adopted and of the kinetics of crosslinking of the composition under consideration.

### II-7 Rubber Articles

Another subject-matter of the present invention is a rubber article comprising a rubber composition according to the invention.

This is because the nature of the rubber composition according to the invention makes it possible to envisage use in the many fields involving rubber articles. Mention may in particular be made of use in various articles preferentially selected from pipes, belts, conveyor belts, tracks, non-pneumatic tyres, pneumatic objects (in particular pneumatic tyres or tyres), footwear soles or surgical gloves. Preferentially, the invention relates to a tyre comprising, in one of its constituent parts, a composition according to the invention.

### III—EXAMPLES

### III-1 Example 1

In a first example illustrating the advantage of the invention, the polymer alone, to be protected against thermal oxidation, is considered. TO corresponds to the case where the polymer is completely devoid of antioxidant system. T1 is a control in which the polymer is protected by a known phenolic antioxidant: 2,2′-methylenebis (6-tert-butyl-4-methylphenol), CAS 119-47-1, sold under the name Vulkanox BKF by Lanxess. The composition C1 illustrates the present invention and contains the polymer, protected against oxidation by ethyl gallate, in an amount equal in molarity to the 2.5 phr of Vulkanox BKF.

### Oxidation Resistance, “OIT”

In order to compare the antioxidant activity of the invention in this particular case, the OIT (Oxidation Induction Time) method, which describes the delay in oxidation, measured by DSC, brought about by the presence of an antioxidant at high temperature (160° C.) when a gas stream in contact with the composition is changed from helium to pure oxygen. The measurements were carried out according to Standard ISO 11357-6 of 2018. The result is expressed in minutes.

The details of the procedure followed for this determination are summarized in Table 1 below:

TABLE 1

| | DSC3 + Mettler Toledo |
|---|---|
| Temperature | Isothermal at 60° C.-2 minutes (Helium-40 ml/min) |
| gradient | From 60° C. to 160° C. at 20° C./min (Helium-40 ml/min) |
| used | Isothermal at 160° C.-2 minutes (Helium-40 ml/min) |
| | Isothermal at 160° C.-8 hours (Oxygen-40 ml/min) |
| Crucibles | 40 μl copper crucible-without lid |
| used | |
| Sample | Between 10 and 11 mg |
| weight | |

The compositions tested (in phr) and the results obtained are presented in Table 2.

TABLE 2

| Composition | T-0 | T-1 | C-1 |
|---|---|---|---|
| NR (1) | 100 | 100 | 100 |
| Antioxidant (2) | | | 1.5 |
| Antioxidant (3) | | 2.5 | |
| t_{induction} (min) | 3 | 120 | 109 |

(1) Grade of natural rubber
(2) Ethyl gallate, >96% in purity, from Sigma-Aldrich
(3) 2,2′-Methylenebis(6-tert-butyl-4-methylphenol), Vulkanox BKF, from Lanxess

It is found that the composition in accordance with the invention makes it possible to very significantly improve the OIT, going from 3 min to 109 min. Moreover, it is found, unexpectedly and surprisingly, that the composition in accordance with the invention, which contains an ester of gallic acid which can be of natural and renewable origin, is comparable to the control composition T-1, which contains an antioxidant, of fossil origin, known and used for being very active against thermal oxidation in rubber compositions.

### III-2 Example 2

The object of Example 2 is to measure the performance qualities of resistance to ageing of the invention subjected to a thermal oxidative treatment by comparing a composition in accordance with the invention (C2) respectively with two control compositions (T2 and T3).

The rubber compositions were prepared as described in point II.6 above, using an internal mixer (non-productive phase) where the majority of the ingredients are incorporated. The “productive” phase is carried out on an external device and concerns the incorporation of the sulfur and the accelerator. The various compositions were shaped, vulcanized in the form of a plate and subjected to a thermal oxidizing treatment at 77° C. for 0 and 7 days. For each of these points, the properties at break are characterized by uniaxial tensile measurements (modulus, elongation).

### Limiting Properties, Modulus and Elongation at Break

These tensile tests make it possible to determine the elasticity stresses and the properties at break. Unless otherwise indicated, they are carried out in accordance with French Standard NF ISO37 of December 2005.

The breaking stresses (in MPa) and the elongations at break (in %) are measured under standard conditions of temperature (23° C., plus or minus 2° C.) and of humidity (50%, plus or minus 10%, relative humidity). Processing the tensile recordings also makes it possible to plot the curve of modulus as a function of the elongation.

The compositions tested are presented in Table 3 (in phr) and the results obtained are presented in Table 4, in base 100.

TABLE 3

| Composition | T2 | T3 | C2 |
|---|---|---|---|
| Natural rubber (1) | 100 | 100 | 100 |
| Antioxidant (2) | — | 2.5 | — |
| Ethyl gallate (3) | — | — | 1.5 |
| Carbon black (4) | 60 | 60 | 60 |
| Stearic acid | 1 | 1 | 1 |
| Zinc oxide | 8 | 8 | 8 |
| Cobalt salt (5) | 1 | 1 | 1 |
| Accelerator (6) | 1 | 1 | 1 |
| Sulfur | 5 | 5 | 5 |

(1) Natural rubber
(2) 2,2-Methylenebis(6-tert-butyl-4-methylphenol), sold by Lanxess under the name Vulkanox BKF
(3) Ethyl gallate at >96% in purity, from Sigma-Aldrich
(4) Carbon black of ASTM N375 grade from Cabot
(5) Cobalt acetylacetonate from Sigma-Aldrich
(6) tert-Butylbenzothiazolesulfenamide (TBBS) from Solutia

TABLE 4

| Property measured | Ageing time | T2 | T3 | C2 |
|---|---|---|---|---|
| Modulus (%) | initial | 100 | 108 | 109 |
| | 7 days | 100 | 138 | 104 |
| Elongation at break (%) | initial | 100 | 133 | 154 |
| | 7 days | 100 | 154 | 173 |

The results presented, expressed in base 100 for the composition T2 for each point of the modulus and of the elongation at break during the ageing in Table 4 above, show that the composition according to the invention makes it possible to better preserve the mechanical properties after ageing for 7 days. The illustration thereof can be seen in that the properties at break and more particularly the elongation of the composition C2 according to the invention contract less rapidly than those of the composition T2, which does not comprise any protective agent.

Moreover, it is observed that the composition C2 in accordance with the invention exhibits an improvement in the elongation at break compared with the composition T3 initially and after ageing for 7 days. A person skilled in the art will know how to make best use of the compromise in these two properties (modulus and elongation at break) from the viewpoint of the targeted applications.

1.-11. (canceled)

12. A rubber composition based on at least a diene elastomer, a reinforcing filler, a crosslinking system and a phenolic antioxidant of general formula (I) below 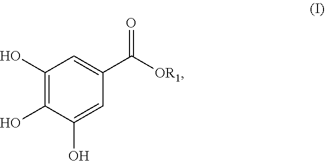
wherein the R₁ radical represents an alkyl group comprising from 1 to 18 carbon atoms, an aryl group comprising from 6 to 10 carbon atoms or a hydrocarbon group of 2 to 12 carbon atoms comprising a heteroatom selected from O, N or S.

13. The rubber composition according to claim 12, wherein the diene elastomer is selected from the group consisting of polybutadienes (BRs), natural rubber (NR), synthetic polyisoprenes (IRs), butadiene copolymers, isoprene copolymers and mixtures thereof.

14. The rubber composition according to claim 12, wherein the diene elastomer is natural rubber (NR).

15. The rubber composition according to claim 12, wherein the phenolic antioxidant of general formula (I) is such that the R₁ radical is a methyl, ethyl, propyl, isopropyl, butyl, isobutyl, sec-butyl, tert-butyl or isopentyl group.

16. The rubber composition according to claim 12, wherein the phenolic antioxidant of general formula (I) is ethyl gallate.

17. The rubber composition according to claim 12, wherein a content of the phenolic antioxidant is within a range extending from 0.2 to 10 phr.

18. The rubber composition according to claim 12, wherein the reinforcing filler is selected from the group consisting of carbon blacks, silicas and mixtures thereof.

19. The rubber composition according to claim 12, wherein a total content of reinforcing filler is within a range extending from 10 to 200 phr.

20. A rubber article comprising the rubber composition according to claim 12.

21. The rubber article according to claim 20, wherein the rubber article is selected from pipes, belts, conveyor belts, tracks, pneumatic objects, footwear soles and surgical gloves.

22. A tire comprising the rubber composition according to claim 12.
